(19) United States
(12) Patent Application Publication
(10) Pub. No.: US 2024/0257258 A1
(43) Pub. Date: Aug. 1, 2024

(54) SYSTEM AND METHOD FOR OMNIDIRECTIONAL SYNCING OF PAYMENT DATA

(71) Applicant: Chargezoom Inc., Irvine, CA (US)

(72) Inventor: Matthew Dubois, Irvine, CA (US)

(21) Appl. No.: 18/626,059

(22) Filed: Apr. 3, 2024

Related U.S. Application Data
(63) Continuation-in-part of application No. 17/587,351, filed on Jan. 28, 2022.
(60) Provisional application No. 63/285,063, filed on Dec. 1, 2021.

(51) Int. Cl. G06Q 40/06

(52) U.S. Cl. CPC G06Q 40/06

(57) ABSTRACT

A computer system for reconciling cashless financial transactions across distinct data platforms can include: at least one processor; and memory including a set of instructions for reconciling cashless financial transactions across distinct data platforms, wherein the set of instructions, with the at least one processor, is configured to cause the computer system to: receive payment data for a cashless transaction from a payment processing data platform; receive invoice data for the cashless transaction from an accounting data processing platform; reconcile the payment data for the cashless transaction with the invoice data for the cashless transaction; and render a display of the reconciled cashless transaction data to a user associated with the transaction.

### CROSS-REFERENCES TO RELATED APPLICATIONS

The present application is a continuation-in-part (CIP) of, and claims the benefit of and priority to, U.S. Non-Provisional application Ser. No. 17/587,351, filed on Jan. 28, 2022, which claims priority to U.S. Provisional Patent Application No. 63/285,063, filed on Dec. 1, 2021. The subject matter thereof is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable.

### REFERENCE TO SEQUENCE LISTING OR COMPUTER PROGRAM LISTING APPENDIX

Not Applicable.

### BACKGROUND

The present invention relates to the field of cashless payment technologies and, more particularly, to a system and method for omnidirectional syncing of data, including data sharing, achieved by manipulating data where the result and integrity remain intact while modifying the data.

An increasing number of businesses and consumers are utilizing cashless payment methods including credit cards and near field communication (NFC) devices to provide payment for goods and services. A cashless transaction can include a point of sale input (e.g., a card swiper, website data entry, etc.), a payment gateway in communication with the point of sale input that functions to transmit payment details to the payment processor, and a merchant-side set of software tools such as an enterprise resource planning (ERP) software platform or an accounting software suite.

Typical payment gateways include a technological feature in which a merchant (user) can access or retrieve a set of transactions in a first data format (e.g., CSV) and then manually upload, input, and/or reconcile the set of transactions into a second data format within the ERP or accounting software platform. Similarly, existing technologies are unable to map, transform, match, normalize, standardize, and/or reconcile invoice and sales data, thus requiring additional manual data entry and reconciliation. To date, existing technologies are also unable to automatically receive, access, input, and/or generate complete transaction data sets, thus requiring additional manual data entry (if any) and/or excessive recoding, customization, or additions to existing technologies (e.g., ERM, CRM, accounting platforms).

Accordingly, an improved system and method for automatically and omnidirectionally synchronizing data within a cashless payment network can be beneficial.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Certain embodiments of the present invention can provide solutions to the technical problems and needs in the art that have not yet been fully identified, appreciated, or solved by current cashless payment network technologies. For example, some embodiments of the present invention pertain to a method, system, and/or computer program product for automatically synchronizing data sets between merchant-side software applications and payment gateways.

In one embodiment, a computer-implemented method for reconciling cashless financial transactions across distinct data platforms includes: by a computer system, receiving payment data for a cashless transaction from a payment processing data platform; by the computer system, receiving invoice data for the cashless transaction from an accounting data processing platform; by the computer system, reconciling the payment data for the cashless transaction with the invoice data for the cashless transaction; and by the computer system, rendering a display of the reconciled cashless transaction data to a user associated with the transaction.

In some embodiments, the method can also include, by the computer system, transmitting the reconciled cashless transaction data to the accounting data processing platform.

In some embodiments, the method can also include, in response to a type of accounting data processing platform, by the computer system, mapping a set of data fields from the payment data into a set of data fields from the invoice data such that the reconciled cashless transaction data is readable by the accounting data processing platform.

In some embodiments, the method can also include: receiving, from the accounting data platform at the computer system, an application programming interface (API) call requesting the reconciled cashless transaction data; by the computer system, authenticating the accounting data platform with the user associated with the cashless transaction; and in response to an authenticated API call, transmitting the reconciled cashless transaction data from the computer system to the accounting data platform.

In some embodiments, the method can also include, prior to rendering the display of the reconciled cashless transaction data to a user associated with the cashless transaction: by the computer system, mapping a set of data fields from the payment data into a set of data fields from the invoice data; by the computer system, hosting a database accessible by the user associated with the cashless transaction; by the computer system, storing the reconciled transaction data in a database accessible by the user associated with the cashless transaction; and by the computer system, permitting remote access to the reconciled cashless transaction data in the database in response to authentication of a device associated with the user associated with the cashless transaction.

In some embodiments, the method can also include, wherein receiving payment data for the cashless transaction from a payment processing data platform includes: by the computer system, submitting an API call to the payment processing data platform, the API call including a unique identifier including one or more of: the user associated with the cashless transaction; a cashless payment identifier; a cashless transaction identifier; a purchaser identifier; or a vendor identifier.

In some embodiments, the method can also include, wherein receiving invoice data for the cashless transaction from an accounting data processing platform includes: by the computer system, submitting an API call to the accounting data processing data platform, the API call including a unique identifier including one or more of: the user associated with the transaction; a cashless payment identifier; a cashless transaction identifier; a purchaser identifier; or an invoice identifier.

In another embodiment, a computer system for reconciling cashless financial transactions across distinct data platforms can include: at least one processor; and memory including a set of instructions for reconciling cashless financial transactions across distinct data platforms, wherein the set of instructions, with the at least one processor, is configured to cause the computer system to: receive payment data for a cashless transaction from a payment processing data platform; receive invoice data for the cashless transaction from an accounting data processing platform; reconcile the payment data for the cashless transaction with the invoice data for the cashless transaction; and render a display of the reconciled cashless transaction data to a user associated with the transaction.

In some embodiments, the computer system is further configured to transmit the reconciled cashless transaction data to the accounting data processing platform.

In some embodiments, the computer system is further configured to, in response to a type of accounting data processing platform, map a set of data fields from the payment data into a set of data fields from the invoice data such that the reconciled cashless transaction data is readable by the accounting data processing platform.

In some embodiments, the computer system is further configured to: receive, from the accounting data platform, an application programming interface (API) call requesting the reconciled cashless transaction data; authenticate the accounting data platform with the user associated with the cashless transaction; and in response to an authenticated API call, transmit the reconciled cashless transaction data to the accounting data platform.

In some embodiments, the computer system is further configured to, prior to rendering the display of the reconciled cashless transaction data to a user associated with the cashless transaction: map a set of data fields from the payment data into a set of data fields from the invoice data; host a database accessible by the user associated with the cashless transaction; store the reconciled transaction data in a database accessible by the user associated with the cashless transaction; and permit remote access to the reconciled cashless transaction data in the database in response to authentication of a device associated with the user associated with the cashless transaction.

In some embodiments, the computer system is further configured to submit an API call to the payment processing data platform, the API call including a unique identifier including one or more of: the user associated with the cashless transaction; a cashless payment identifier; a cashless transaction identifier; a purchaser identifier; or a vendor identifier.

In some embodiments, the computer system is further configured to submit an API call to the accounting data processing data platform, the API call including a unique identifier including one or more of: the user associated with the transaction; a cashless payment identifier; a cashless transaction identifier; a purchaser identifier; or an invoice identifier.

In another embodiment, a computer program embodied on a non-transitory computer readable medium, when executed, is configured to cause at least one processor to: receive payment data for a cashless transaction from a payment processing data platform; receive invoice data for the cashless transaction from an accounting data processing platform; reconcile the payment data for the cashless transaction with the invoice data for the cashless transaction; and render a display of the reconciled cashless transaction data to a user associated with the transaction.

In some embodiments, the computer program product is further configured to cause at least one processor to transmit the reconciled cashless transaction data to the accounting data processing platform.

In some embodiments, the computer program product is further configured to cause at least one processor to: in response to a type of accounting data processing platform, map a set of data fields from the payment data into a set of data fields from the invoice data such that the reconciled cashless transaction data is readable by the accounting data processing platform; receive, from the accounting data platform, an application programming interface (API) call requesting the reconciled cashless transaction data; authenticate the accounting data platform with the user associated with the cashless transaction; and in response to an authenticated API call, transmit the reconciled cashless transaction data to the accounting data platform.

In some embodiments, the computer program product is further configured to cause at least one processor to, prior to rendering the display of the reconciled cashless transaction data to a user associated with the cashless transaction: map a set of data fields from the payment data into a set of data fields from the invoice data; host a database accessible by the user associated with the cashless transaction; store the reconciled transaction data in a database accessible by the user associated with the cashless transaction; and permit remote access to the reconciled cashless transaction data in the database in response to authentication of a device associated with the user associated with the cashless transaction.

In some embodiments, the computer program product is further configured to submit an API call to the payment processing data platform, the API call including a unique identifier including one or more of: the user associated with the cashless transaction; a cashless payment identifier; a cashless transaction identifier; a purchaser identifier; or a vendor identifier.

In some embodiments, the computer program product is further configured to submit an API call to the accounting data processing data platform, the API call including a unique identifier including one or more of: the user associated with the transaction; a cashless payment identifier; a cashless transaction identifier; a purchaser identifier; or an invoice identifier.

These and other embodiments, and variations and alternatives thereof, are described below in detail with reference to the following figures.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a schematic diagram of a computer system operating environment according to an embodiment of the present invention;

FIG. 2 is an architectural diagram of a computer system configured to automatically and omnidirectionally synchronize disparate data sets within a cashless payment network, according to an embodiment of the present invention;

FIG. 3 is a schematic representation of an example operational environment of a computer system, according to an embodiment of the present invention;

FIG. 4 is a flow chart representation of a method executable by the computer system, according to an embodiment of the present invention;

FIG. 5 is a schematic view of a user interface, according to an embodiment of the present invention;

FIG. 6 is a schematic view of a user interface, according to an embodiment of the present invention; and

FIG. 7 is a schematic view of a user interface, according to an embodiment of the present invention.

FIG. 8 is a logic diagram of normalizing data for synchronization across platforms, according to an embodiment of the present invention.

FIG. 9 is a flow diagram of an example method of normalizing data for synchronization across platforms, according to an embodiment of the present invention.

FIG. 10 is a flow diagram of an example method of normalizing data for synchronization across platforms, according to further embodiments of the present invention.

FIG. 11 is a schematic diagram illustrating the exchange of financial data in accordance with the exemplary method of FIG. 10, according to an embodiment of the present invention.

FIG. 12 is an illustration of adjusted financial data in accordance with the exemplary method of FIG. 10, according to an embodiment of the present invention.

### DETAILED DESCRIPTION

### Overview

Generally, various embodiments of the computer system 100 are configured to automatically reconcile and synchronize distinct data sets in an end-to-end manner between a credit card network and a merchant accounting system, thereby eliminating technological inefficiencies and errors on the par to the payment gateway and the merchant (user). In operation, various embodiments of the computer system 100 can be configured to automatically pull invoice date from the merchant accounting software and also pull the transaction identification data from the payment gateway into the merchant accounting software and synchronize, apply, and/or reconcile the transaction identification data with the invoice. In some embodiments, the computer system 100 can then push, transmit, or transfer the reconciled transaction data to one or both of the accounting platform or the payment gateway platform. In other embodiments, the computer system 100 can selectively permit user access into an account (e.g., a cloud-based platform) that permits a user to access, manipulate, transfer, or transmit the reconciled transaction data. In still other embodiments, the computer system 100 can be configured to host and interface with a set of user accounts (e.g., users 1 through N), each of which is associated with its own accounting platform and one or more payment gateways. Therefore the computer system 100 can function as a cloud-based, end-to-end, accounting, invoicing, and reconciliation platform that allows an arbitrary number of users to match and reconcile payment and invoice data for any number of cashless payments seamlessly and automatically.

### 2. Benefits

As described in detail below, the computer system 100 can be configured to retrieve, standardize, normalize, and reconcile financial data sets between a merchant's accounting system (e.g., CRM, accounting and/or ERP software), a payment gateway or payment processing system, and one or more cashless payment entities such as a credit card company, bank, or other electronic payment platform. In doing so, the system can synchronize/push invoice and merchant data to the payment platform, synchronize/pull transaction data from the payment gateway into the merchant accounting system, generate and/or create actual payment records within the merchant accounting system, and reconcile and/or synchronize the transaction cycle from invoicing, payment, returns, and/or refunds on behalf of the merchant and the payment platform.

One benefit of the various embodiments of the computer system 100 is that the computer system 100 provides seamless, end-to-end fidelity of the entirety of the transaction (including invoicing, payment, returns, and/or refunds) without the need for additional technologies or human intervention. In doing so, the computer system 100 can increase the efficiency with which both merchants and payment processors reconcile, settle, and close out transaction cycles, thus permitting real time or near real time transfer of funds between the various entities associated with the transaction. Moreover, the computer system 100 can eliminate any need for excessive or additional software tools, scripts, or programs to assist in the import, export, translation, and reconciliation of the financial and transactional data associated with a purchase, sale, return, and/or refund. The computer system 100 can also greatly increase the efficiencies of the underlying software platforms by providing seamless and real-time or near real-time data exchange on all sides of a transaction, thereby increasing the pace at which the ancillary software platforms (e.g., CRM software, ERP software, accounting software, payment processing software) can process and close each phase of a transaction.

### 3. Computer System Architecture

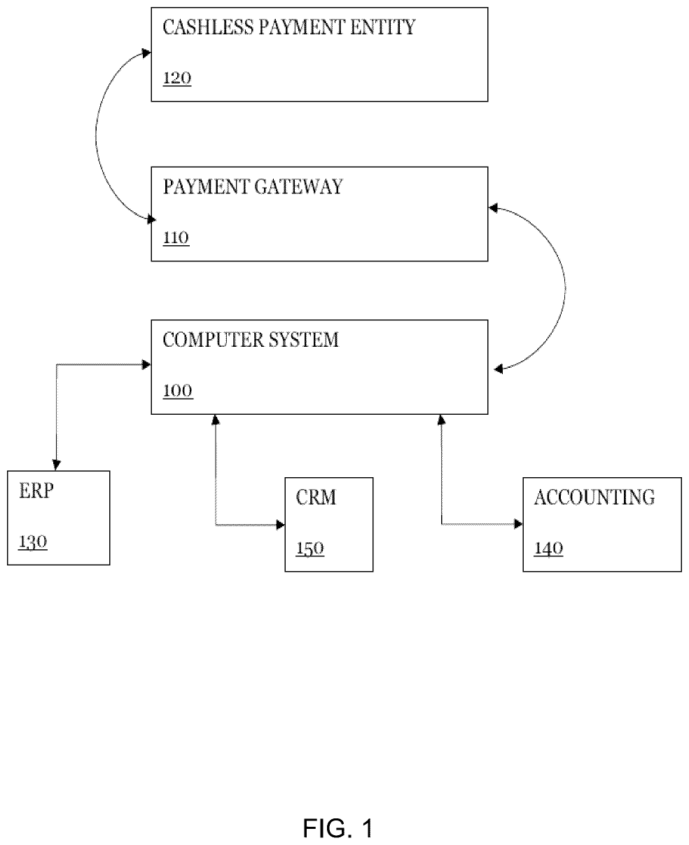

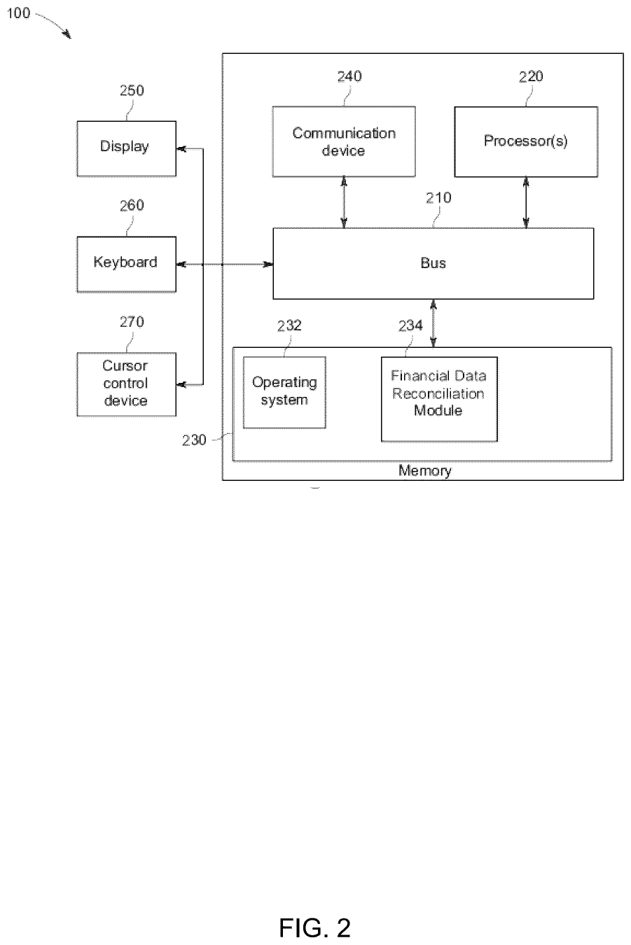

Generally, the methods and techniques described herein are performed by a computer system 100, as shown in FIG. 1. For example, FIG. 2 is an exemplary architectural diagram illustrating a computer system 100 configured to automatically reconcile and synchronize distinct data sets in an end-to-end manner between a credit card network and a merchant accounting system according to an embodiment of the present invention. In some embodiments, the computer system 100 is configured as a cloud based platform or service that can access other software applications, services, servers, datasets, and/or databases associated with the user-merchant, payor, credit card network, etcetera.

In some embodiments, the computer system 100 can be one or more of the computing systems depicted and/or described herein. The computer system 100 can include a bus 210 or other communication mechanism for communicating information, and one or more processor(s) 220 coupled to the bus 210 for processing information. The processor(s) 220 can be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. The processor(s) 220 can also have multiple processing cores, and at least some of the cores can be configured to perform specific functions. Multi-parallel processing can be used in some embodiments. In certain embodiments, at least one of the processor(s) 220 can be a neuromorphic circuit that includes processing elements that mimic biological neurons. In some embodiments, neuromorphic circuits might not require the typical components of a Von Neumann computing architecture.

The computer system 100 can also include a memory 230 for storing information and instructions to be executed by the processor(s) 220. The memory 230 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media can be any available media that can be accessed by the processor(s) 220 and can include volatile media, non-volatile media, or both. The media can also be removable, non-removable, or both.

Additionally, the computer system 100 can include a communication device 240, such as a transceiver, to provide access to a communications network via a wireless and/or wired connection. In some embodiments, the communication device 240 can be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the claimed invention. In some embodiments, the communication device 240 can include one or more antennas that are singular, arrayed, phased, switched, beamforming, beamsteering, a combination thereof, and or any other antenna configuration without deviating from the scope of the claimed invention.

The processor(s) 220 are further coupled via the bus 210 to a display 250, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. The display 250 can be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etcetera. Any suitable display device and haptic I/O can be used without deviating from the scope of the claimed invention.

A keyboard 260 and a cursor control device 270, such as a computer mouse, a touchpad, etc., are further coupled to the bus 210 to enable a user to interface with the computer system 100. However, in certain embodiments, a physical keyboard and mouse might not be present, and the user can interact with the computer system 100 solely through display 250 and/or a touchpad (not shown). Any type and combination of input devices can be used as a matter of design choice. In certain embodiments, no physical input device and/or display is present. For instance, the computer system 100 can be configured as a cloud-based or remote server-based system, in which case the user can interact with computer system 100 remotely via another system (not shown) in communication therewith. In still other embodiments, the computer system 100 can operate autonomously, semi-autonomously, or by implementing machine learning techniques.

The memory 230 stores software modules that provide functionality when executed by the processor(s) 220. The modules can include an operating system 232 for computer system 100. The modules can further include a financial data reconciliation module 234 that is configured to perform all or part of the processes, techniques, or methods described herein or derivatives thereof. The computer system 100 can include one or more additional modules that include additional functionality.

One skilled in the art will appreciate that a “computer system” could be embodied as a server, an embedded computing system, a personal computer, a console, a personal digital assistant (PDA), a cell phone, a tablet computing device, a quantum computing system, or any other suitable computing device, or combination of devices without deviating from the scope of the claimed invention. Presenting the above-described functions as being performed by a “computer system” is not intended to limit the scope of the claimed invention in any way, but is intended to provide one example of the many embodiments of the claimed invention. Indeed, methods, systems, and apparatuses disclosed herein can be implemented in localized and distributed forms consistent with computing technology, including cloud computing systems.

It should be noted that some of the computer system 100 features described in this specification have been presented as modules, in order to emphasize their implementation independence more particularly. For example, a module can be implemented as a hardware circuit comprising custom very large scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices, graphics processing units, or the like.

A module can also be at least partially implemented in software for execution by various types of processors. An identified unit of executable code can, for instance, include one or more physical or logical blocks of computer instructions that can, for instance, be organized as an object, procedure, or function. Nevertheless, the executables of an identified module need not be physically located together, but can include disparate instructions stored in different locations that, when joined logically together, comprise the module and achieve the stated purpose for the module. Further, modules can be stored on a computer-readable medium, which can be, for instance, a hard disk drive, flash device, RAM, tape, and/or any other such non-transitory computer-readable medium used to store data without deviating from the scope of the invention.

Indeed, a module of executable code could be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network.

The process steps performed in by the system 100 can be performed by a computer program, encoding instructions for the processor(s) to perform at least part of the process(es), techniques, or methods described herein, in accordance with embodiments of the claimed invention. The computer program can be embodied on a non-transitory computer-readable medium. The computer-readable medium can be, but is not limited to, a hard disk drive, a flash device, RAM, a tape, and/or any other such medium or combination of media used to store data. The computer program can include encoded instructions for controlling the processor(s) of a computer system (e.g., the processor(s) 220 of the computer system 100 of FIG. 2) to implement all or part of the process steps described in herein, which can also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

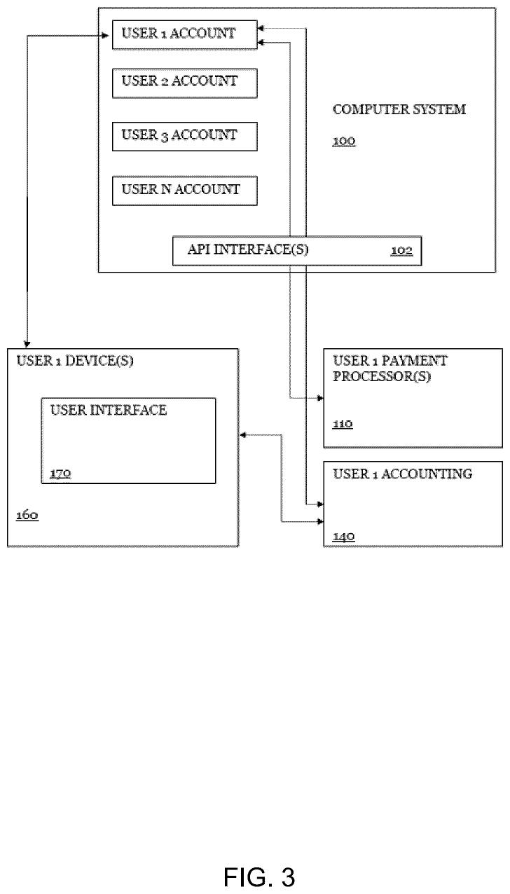

As shown in FIGS. 1 and 3, in one embodiment the computer system 100 can be connected, for example through one or more application programming interfaces (APIs) 102, to a payment processor 110, which is in turn in communication through industry standard and encrypted channels with one or more cashless payment entities 120 (e.g., credit card networks, banks, electronic payment systems, etcetera). The computer system 100 can also be connected to one or more merchant-side financial software platforms, including an enterprise resource planning (ERP) platform 130, an accounting platform 140, and/or a customer relations management (CRM) platform 150. In some embodiments, one or more of the ERP platform 130, the accounting platform 140, and the CRM platform 150 can be cloud-based software-as-a-service (Saas) computing platforms. Additionally or alternatively, in some embodiments, one or more of the computer system 100, the payment processor 110, and the cashless payment entity 120 can be implemented in a remote server and/or cloud-based software platform.

In other embodiments, the computer system 100 can be connected and/or connectable to one or more of the ERP platform 130, the accounting platform 140, the CRM platform 150 the payment processor 110, and/or the cashless payment entity 120 via one or more application programming interfaces (APIs) that permit the computer system 100 to: submit a request for data from the associated platform; receive or pull data from the associated platform; respond to a request for data from the associated platform; and transmit or push data to the associated platform. In some embodiments, the computer system 100 and associated platforms can execute REST APIs. In other embodiments, the computer system 100 can associated platforms can execute SOAP APIs. In still other embodiments, the computer system 100 and associated platforms can execute APIs of other types or formats.

As shown in FIGS. 1 and 3, embodiments of the computer system 100 can: retrieve and/or access transaction data from the payment gateway 110; and push the transaction data into the ERP software 130, accounting software 140, and/or CRM software 150 through one or more API interfaces 102. In operation, the computer system 100 can further function to transform, translate, and/or map transaction data into a universally or omni-directional readable format such that, for an example cashless transaction, the payment data receivable from the payment processor 110 is imported into and/or reconciled with the invoice data from the accounting platform 140. Therefore, the computer system 100 can: retrieve, map, and reconcile invoice and payment data from a transaction into a single data form that includes all of the necessary data for the merchant and/or the payment processor 110 to close, amend, or alter a particular cashless transaction.

As shown in FIG. 3, the computer system 100 can host and intermediate a set of user accounts, each of which is connected to and/or associated with a user device 160, a user payment processor(s) 110, and/or a user accounting platform 140. For example, an example user (USER 1) can, through her associated user device 160, remotely access her account on the computer system 100, connect her accounting platform 140 to the computer system 100, and connect her payment processor(s) 140 to the computer system 100. In response, the computer system 100 execute the methods and techniques described herein to: receive payment data for a cashless transaction from the payment processing data platform 110; receive invoice data for the cashless transaction from an accounting data processing platform 140; reconcile the payment data for the cashless transaction with the invoice data for the cashless transaction; and render a display of the reconciled cashless transaction data to a user associated with the transaction. In one variation of the embodiments, the computer system 100 can render a display for the user viewable on a user interface 170 on her user device 160. In another variation of the embodiments, the computer system 100 can push or transmit the reconciled cashless transaction data to the accounting data processing platform 110 and/or the payment processing platform 110 such that the user's accounting records are automatically reconciled and updated and/or the payment processing entity has a confirmed and reconciled dataset of the cashless transaction that it is processing on behalf of the user.

In another variation of the embodiments, the computer system 100 can further manipulate, transform, normalize, and/or map disparate data types or data formats into a single data format for the user. For example, certain accounting principles or regulations may require accounting records to be presented in a particular format or with certain prescribed fields, for example dual entry and generally accepted accounting principles (GAAP) accounting standards. Accordingly, the computer system 100 can also determine a type of accounting platform 140 in use by the user or receive an accounting platform configuration from either the user or the accounting platform 140. In response to the type of accounting data processing platform, the computer system 100 can then map a set of data fields from the payment data into a set of data fields from the invoice data such that the reconciled cashless transaction data is readable by the accounting data processing platform 140.

Additionally or alternatively, the computer system 100 can, in response to the type of payment processing platform, map a set of data fields from the invoice data into a set of data fields from the payment data such that the reconciled cashless transaction data is readable by the payment processing data platform 110.

In another variation of the embodiments, the computer system 100 can directly transmit or import the reconciled cashless transaction data into the accounting data platform 140, which is either directly accessible to the user on the user device 160 and/or remotely accessible to the user via a connection to a cloud-based or server-based accounting data platform 140. In this variation of the embodiments, the computer system 100 can receive an API call from the accounting data platform 140 requesting the reconciled cashless transaction data. Either in concert with or in addition to the API call, the computer system 100 can then authenticate the accounting data platform 140 (e.g., a user account on the accounting data platform 140) with the user associated with the cashless transaction. In response to an authenticated API call, the computer system 100 can then transmit the reconciled cashless transaction data from the computer system 100 to the accounting data platform 140.

In another variation of the embodiments, the computer system 100 can directly transmit or import the reconciled cashless transaction data into the payment processing platform 110, which is either directly accessible to the user on the user device 160 and/or remotely accessible to the user via a connection to a cloud-based or server-based payment processing platform 110. In this variation of the embodiments, the computer system 100 can receive an API call from the payment processing platform 110 requesting the reconciled cashless transaction data. Either in concert with or in addition to the API call, the computer system 100 can then authenticate the payment processing platform 110 (e.g., a user account on the payment processing platform 110) with the user associated with the cashless transaction. In response to an authenticated API call, the computer system 100 can then transmit the reconciled cashless transaction data from the computer system 100 to the payment processing platform 110.

In another variation of the embodiments, the computer system 100 can be configured to host a user account (e.g., a cloud-based hosted service) through which the user can access her reconciled cashless transaction data via her user device 160. Accordingly, prior to rendering the display of the reconciled cashless transaction data to the user, the computer system 100 can map a set of data fields from the payment data into a set of data fields from the invoice data and host a database accessible by the user associated with the cashless transaction on which database the transaction data (raw and reconciled) is stored and accessible. The computer system 100 can further permit remote access to the reconciled cashless transaction data in the database in response to authentication of a user device 160 associated with the user. The computer system 100 can authenticate the user device 160 through the initial API setup, described above. Alternatively, the computer system 100 can separately authenticate the user device 160 upon user account login, for example through password entry, authentication challenge question(s), two-factor authentication techniques, biometric authentication, and/or any combination or subcombination of the foregoing.

In other variations of the embodiments, the computer system 100 can request and/or transmit via APIs including identifying data associated with the user, the user account, the transaction, the purchaser, and/or the vendor. For example, in receiving payment data for the cashless transaction from the payment processing data platform 110, the computer system can submit an API call to the payment processing data platform 110 that includes a unique identifier or combination of identifiers. For example, each cashless transaction can include at least the following data: the user (either an individual or an entity), a cashless payment identifier (e.g., a credit card number), a cashless transaction identifier (e.g., an alphanumeric transaction record), a purchaser identifier, and/or a vendor identifier (e.g., for instances in which the vendor and the merchant are non-identical). Therefore, an API call can include one or more identifiers that enables the computer system 100 to readily import, store, access, and manipulate the payment data. For example, an API call can identify: a user (merchant), the credit card number used in the transaction (or a portion thereof), and a purchaser identifier (or a portion thereof such as name, billing zip code, etcetera).

Additionally or alternatively, in receiving invoice data for the cashless transaction from an accounting data processing platform 140, the computer system can submit an API call to the accounting data processing data platform 140 that includes a unique identifier or combination of identifiers. For example, each cashless transaction can include at least the following data: the user (either an individual or an entity), a cashless payment identifier (e.g., a credit card number), a cashless transaction identifier (e.g., an alphanumeric transaction record), a purchaser identifier, and/or an invoice identifier. Therefore, an API call can include one or more identifiers that enables the computer system 100 to readily import, store, access, and manipulate the accounting data. For example, an API call can identify: a user (merchant), the credit card number used in the transaction (or a portion thereof), and an invoice number from the accounting data processing platform 140.

In another variation of the embodiments, the computer system 100 can use any or all of the foregoing identifying data to match accounting data (e.g., invoice data) with the payment data prior to reformatting, importing, exporting, and/or reconciling the data sets.

In another variation of the embodiments, the computer system 100 can adapt, alter, and/or amend invoices and transactions in response to a user input. For example, if the user elects to surcharge an invoice payment, the computer system 100 can: process the updated total (invoice amount plus surcharge amount), synchronize the updated transaction total with the updated invoice with a new line item for the surcharge. Additionally, the computer system 100 can process and update the payment end of the transaction simultaneously or substantially simultaneously with updating the invoice.

### 4. Method

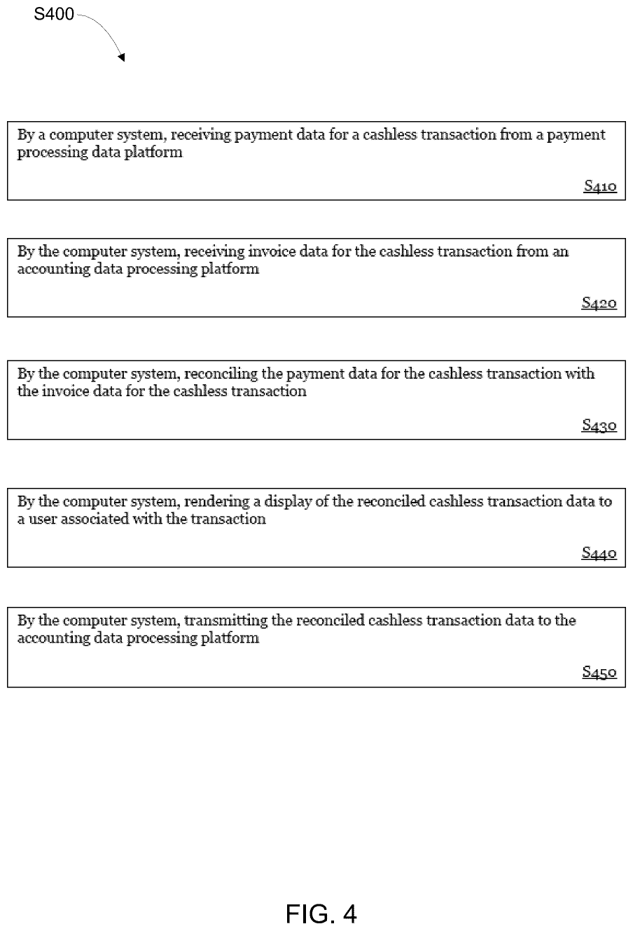

In some variations of the embodiments, the computer system 100 can be configured to implement or execute one or more techniques or methods. As shown in FIG. 4, one method 400 for reconciling cashless financial transactions across distinct data platforms can include: receiving payment data for a cashless transaction from a payment processing data platform in Block S410; and receiving invoice data for the cashless transaction from an accounting data processing platform in Block S420. In this variation of the embodiments, the method S400 can also include: reconciling the payment data for the cashless transaction with the invoice data for the cashless transaction in Block S430; and rendering a display of the reconciled cashless transaction data to a user associated with the transaction in Block S440.

In another variation of the embodiments, the method S400 can also include transmitting the reconciled cashless transaction data to the accounting data processing platform in Block S450.

In another variation of the embodiments, the method S400 can further include: by the computer system, mapping a set of data fields from the payment data into a set of data fields from the invoice data such that the reconciled cashless transaction data is readable by the accounting data processing platform. As noted above, each type of accounting data processing platform and/or payment data processing platform can include one or more fields, data types, or data formats that are desirable and/or necessary for best accounting practices, accounting compliance, and/or information system fidelity. Additionally or alternatively, the method S400 can also include, in response to the type of payment processing platform, mapping a set of data fields from the invoice data into a set of data fields from the payment data such that the reconciled cashless transaction data is readable by the payment processing data platform 110.

In some variations of the embodiments, the computer system 100 can execute one or more blocks of the method S400 via one or more APIs. For example, in some variations of the embodiments, the method S400 can include receiving, from the accounting data platform at the computer system, an application programming interface (API) call requesting the reconciled cashless transaction data. For example, as described above, the accounting data platform associated with the user can, either intermittently, regularly, or upon user request, transmit a request for data via one or more APIs. The method S400 can also include, by the computer system, authenticating the accounting data platform with the user associated with the cashless transaction; and in response to an authenticated API call, transmitting the reconciled cashless transaction data from the computer system to the accounting data platform for rendering, display, manipulation, and/or storage in the accounting data platform.

In still other variations of the embodiments, the method S400 can function on a computer system 100 configured as a cloud-based or server-based software platform through which a user can access her invoice and payment data. In another variation of the embodiment, the computer system 100 can execute one or more blocks of the method S400 prior to rendering the display of the reconciled cashless transaction data to the user. For example, the method S400 can include: by the computer system, mapping a set of data fields from the payment data into a set of data fields from the invoice data; and by the computer system, hosting a database accessible by the user associated with the cashless transaction. In these variations of the embodiments, the method S400 can also include by the computer system, storing the reconciled transaction data in a database accessible by the user associated with the cashless transaction; and by the computer system, permitting remote access to the reconciled cashless transaction data in the database in response to authentication of a device associated with the user associated with the cashless transaction. As noted above, the method S400 can further include blocks, executable by the computer system 100, to ensure proper authentication of the user device to the database, including for example authentication of the user device through the initial API setup, upon user account login (e.g., password entry), based upon authentication challenge question(s), two-factor authentication techniques, biometric authentication, and/or any combination or subcombination of the foregoing.

In still other variations of the embodiments, the computer system 100 can execute the method S400 to match and/or pair the invoice (accounting data) and the payment (payment processing data) in order to manipulate, transform, map, and/or reconcile the paired sets of data into a single, complete data set. As noted above, the computer system 100 can execute additional or alternative blocks of the method S400 to request, via API call, unique transaction identifiers from both the payment processing data platform and the accounting data platform. The unique transaction identifiers can include, for example, any combination or subcombination of the following: the user associated with the cashless transaction; a cashless payment identifier, a cashless transaction identifier, a purchaser identifier, a vendor identifier, and/or an invoice identifier.

### 5. Example Implementations

As described above, the computer system 100 can execute blocks of the method S400 in a distributed network of devices, servers, and/or cloud-based platforms. In some variations of the embodiments, the computer system 100 can be a stand-alone, cloud-based, and remotely accessible computing platform that interacts with ancillary devices, servers, and/or cloud-based platforms. In other variations of the embodiments, the computer system 100 can be integrated into or integral with one of the ancillary devices, servers, and/or cloud based platforms.

For example, in another variation of the embodiments, the computer system 100 can be integrated into or integral with the payment processing platform 110 such that the payment processing platform 110 can provide end-to-end transaction data reconciliation for its merchants/users, along with other benefits of the type described herein.

In another variation of the embodiments, the computer system 100 can be integrated into or integral with the accounting data processing platform 140 such that the accounting data processing platform 140 can provide end-to-end transaction data reconciliation for its merchants/users, along with other benefits of the type described herein.

In still another variation of the embodiments, the computer system 100 can be configured as a stand-alone service (e.g., a cloud-based platform) that interacts with ancillary devices, servers, and/or cloud-based platforms via APIs as described above.

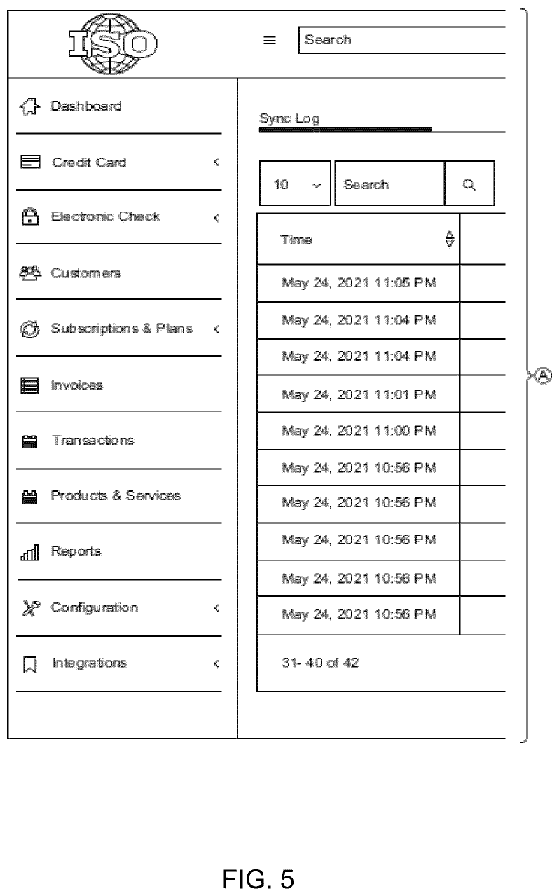

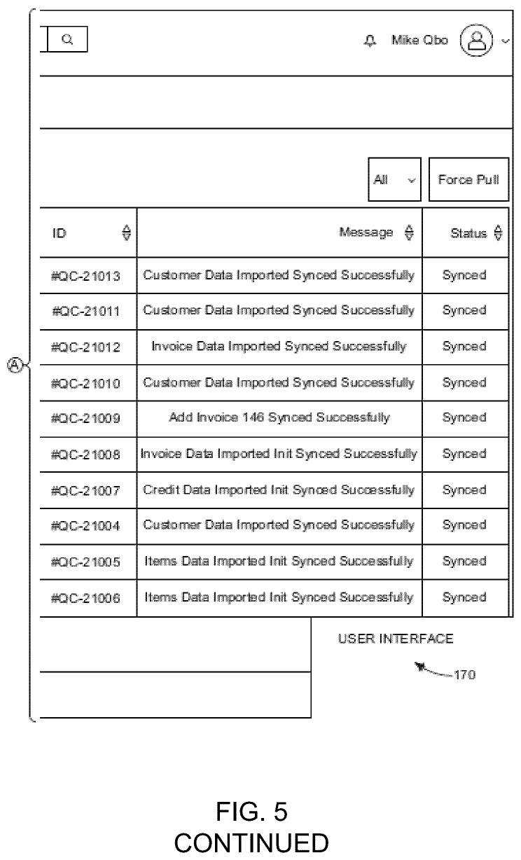

For example, FIGS. 5, 6, and 7 are schematic renditions of a user interface 170 (e.g., rendered and displayed on a user device 160) with a computer system 100 configured as a stand-alone, cloud-based platform. As shown, FIG. 5 depicts a synchronization log displayable to a merchant/user that the computer system 100 renders and displays on the user device 160 to show a user a state/status of the various inter-platform synchronizations implemented by the computer system 100.

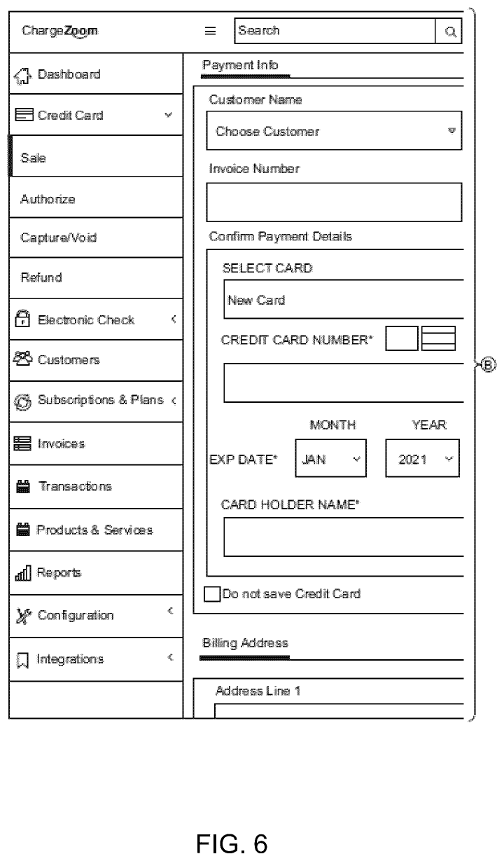

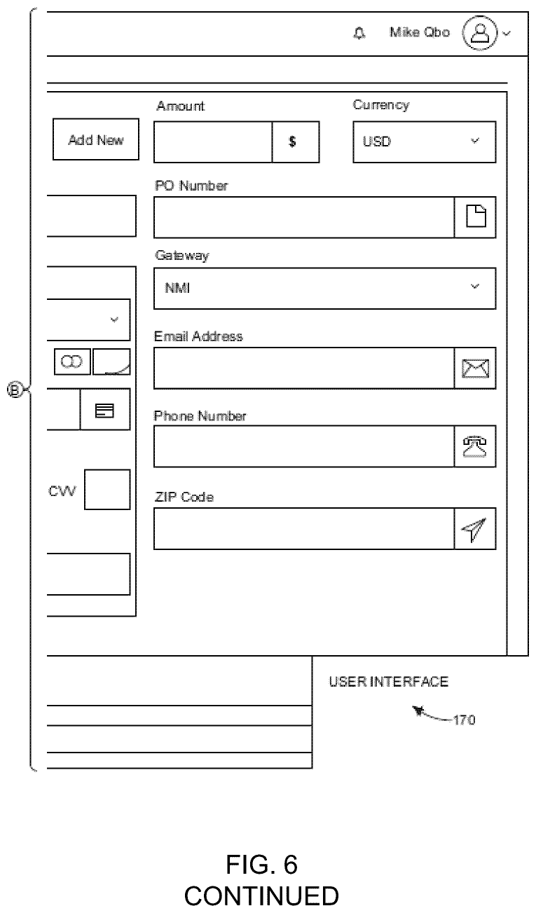

FIG. 6 depicts a payment information input field displayable to a merchant/user through which a merchant/user can input various invoicing data into a set of fields, including for example: customer name, invoice number, amount, PO number, gateway (payment processor identifier), credit card information, purchaser name, billing zip code, etcetera. As noted above, in some variations of the embodiments, the computer system 100 can access some or all of this data in order to properly pair the invoice with the payment processing data.

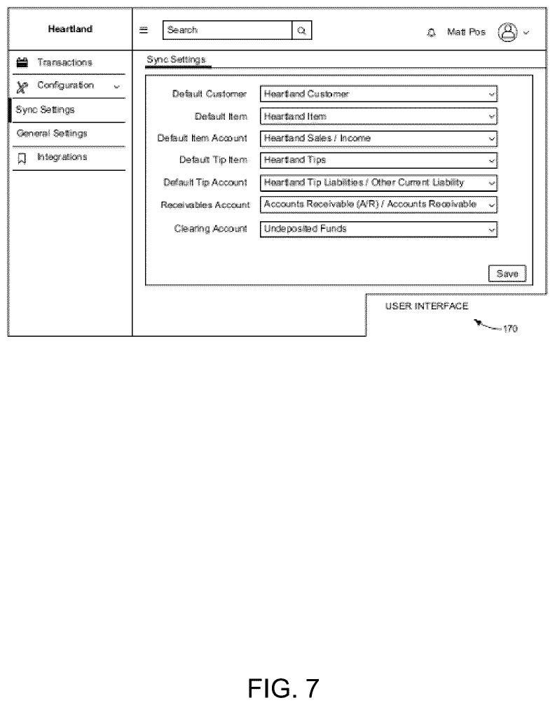

FIG. 7 illustrates a sync settings selection interface displayable to a merchant/user and through which a merchant/user can select one or more parameters of the synchronization and reconciliation techniques and methods described herein. For example, in some variations of the embodiments, the computer system 100 can select customers, items, accounting classifications, and accounts (e.g., accounts on a ledger) that the computer system 100 will synchronize and reconcile in execution of the method S400 described above.

Data may be stored in a variety of formats and in some cases must be synchronized across varying platforms. Such a process can lead to errors and inconsistencies in data, which can cause tracking financial performance to be challenging. An example method for normalizing financial data may provide a way to prepare the data to be synchronized across varying platforms. The system that supports such a process may include a normalization engine that converts financial data from a variety of formats into a normalized format. The normalized data can then be synchronized across the platforms without errors or inconsistencies.

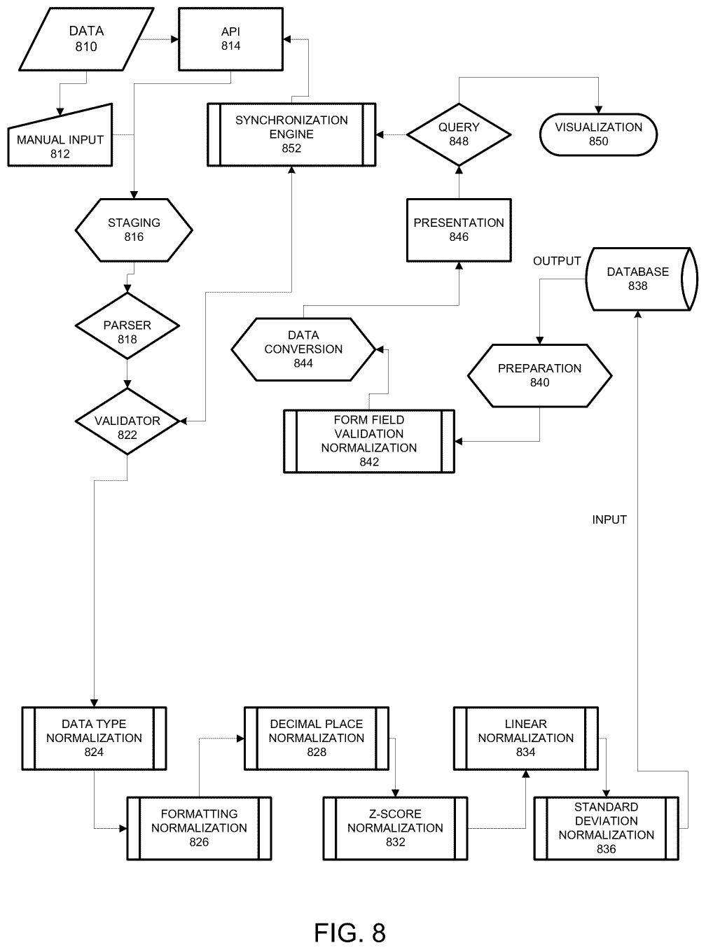

FIG. 8 is a logic diagram of normalizing data for synchronization across platforms, according to an embodiment of the present invention. The system for normalizing financial data may include a normalization process that includes a data repository, and a synchronization engine. A normalization engine may be based on each of normalization processes 824 (e.g., data type normalization), 826 (e.g., formatting normalization), 828 (e.g., decimal place normalization), 832 (e.g., Z-score normalization), 834 (e.g., linear normalization) and 836 (e.g., standard deviation normalization), which collectively convert financial data from a variety of formats into a normalized format.

The data repository or database 838 stores the normalized data. The synchronization engine 852 synchronizes the normalized data across those varying different platforms. The ‘normalization engine’ may also include a parser 818, and a validator 822 as well as a normalizer. In some embodiments, normalizer may include various normalization processes 824-836. Parser 818 parses the financial data from a variety of formats, and validator 822 validates the parsed financial data. The normalizer normalizes the validated financial data. Any of the example normalization processes may also be referred to as procedures which occur as part of a process that includes the one or more normalization procedures.

When validating parsed data, a check may be made to ensure that the data meets certain criteria. The criteria can vary depending on the specific data type and the intended use of the data. In one example, validation of a data field to may be performed to determine whether the data is in a valid format and within a certain range of dates. Other examples may include an email address field being validated to verify a valid data format. A number field may also be validated to ensure that it is within a certain range of numbers. Validating parsed data may prevent errors and inconsistencies in the data especially financial data, where even small errors can have a significant impact.

Parsed data can be validated may performing one or more of checking that a string field is not empty, checking that an email address field is in a valid format, checking that a date field is in a valid format and that it is within a certain range of dates, checking that a number field is within a certain range of numbers, checking that a list of items contains at least one item, checking to make sure that a JSON object contains all of the required fields, etc.

Validating parsed data can be performed using a variety of different approaches. One approach is to use a validation library. Validation libraries provide a set of pre-built validation functions that can be used to validate different types of data, or another approach is a custom written validation code.

Normalizing data may include a process of transforming data into a consistent format so the data can be easily compared and analyzed. Normalization can involve converting data to a common unit of measurement, scaling data to a common range, and/or removing duplicate data. Normalizing data may enable easier data comparison of data received from different sources. For example, if data related to sales figures is received from different countries, the normalization of all such data to a common currency will optimize a data comparison process. Normalizing data permits seamless data analyzation. One example may include data regarding student test scores being normalized to a common scale so that the data can be compared to identify the performance of students from different classes or schools. In another example, data related to customer addresses can be normalized to a common format so that data can be merged from different sources or exported to other systems.

There are a different ways to normalize data, one normalization technique may include converting data to a common unit of measurement, such as when there are sales figures data in both dollars and euros. In this example, converting all of the data values to dollars prior to performing any comparison operations or merging operations may be a type of normalization. Another approach is to scale data to a common range, such as by converting all data values to a common range, such as 0 to 1 or −1 to 1. This can be useful for machine learning algorithms, which often require data to be in a specific range. Removing duplicate data may also be optimal to identify and remove duplicate data records to increase the accuracy and consistency of data.

Financial data can be normalized by converting all data values to a common currency and by scaling the data to a common range. This may enable the comparison of financial data from different sources and to analyze financial trends. Customer data can be normalized by removing duplicate customer records and by converting all customer data to a common format to improve the accuracy and consistency of customer data and make it easier to merge data from different sources or export data to other systems.

The data repository or database 838 stores the normalized financial data. The database 838 may be a relational database, a NoSQL database, or a cloud-based database. The synchronization engine 852 synchronizes the normalized financial data across platforms. Relational databases can be used to store data in tables that are related to each other through common keys or indexes. Examples of relational databases include proprietary platforms, such as MySQL, Oracle, and Microsoft SQL Server. Non-relational databases, such as NoSQL databases are a newer type of database that are designed to handle large amounts of data and unstructured data. NoSQL databases come in a variety of different types, including document databases, key-value stores, column-oriented databases, and graph databases. Examples of NoSQL databases include proprietary platforms, such as MongoDB, Cassandra, and HBase.

The synchronization engine 852 may use a variety of protocols to synchronize the data, such as FTP, SFTP, or HTTPS. The example process may provide optimized accuracy and consistency of financial data, reduced errors and inconsistencies in financial data, improved ability to track financial performance, and improved ability to make informed decisions regarding financial data.

The decimal place normalization 828 may occur in data tables with numerical data types. The process of ensuring that there are two decimal points and/or normalizing the data to two decimal points ‘$D, DDD.CC’ may be one approach to decimal place normalization since some systems do not have a form field requirement of decimal points when processing an amount that is equal to a whole number. Data type normalization 824 may normalize subtypes of numerical data. In one example, a data table using numerical data may be setup as a currency, an accounting number, text, general data, a number, and sometimes as a comma-style type of data. The varying subtypes of numerical data may cause certain applications to respond differently to applied formulas and various analytical treatments. One approach is to identify all types of varying data or accommodate types of data, and normalize those data types to the same data type. In one example, a default data style may be comma-style as it can be easily identified, labeled as a currency or accounting number if a presentation is performed. Also, a comma-style data format tends to undergo fewer updates over time during modifications, and thus a spreadsheet file may remain relevant across varying programs over usage and time.

The formatting normalization process 826 may be more common data strings (e.g., text, not numbers), however, it may be used with numbers as well. In most cases of formatting inconsistencies, one potential issue is with data italics since such formats may be distracting and can prevent inconsistencies, such as decimal places and data types from being identified. The Z-score normalization process may assist with datasets that include numerical values in multiple dimensions with significant differences in size. In one example, if there are values ranging from 10 to 100 in one dimension and values ranging from 100 to 100,000 in another, then it may be burdensome to compare the relative changes between those two separate values. The most common type of normalization process used for data modification may be the z-score normalization. A z-score process normalizes each data point to a particular standard deviation using the following formula:

$${x}^{′} = \frac{X - μ}{σ} \qquad Equation ( 1 )$$

where x′ is the data value, μ is the mean of the dataset, and σ is the standard deviation.

Linear normalization 834 is a simple and flexible normalization technique, which may include establishing a new “base” reference for each data point. Often called “max-min” normalization, this process permits taking the difference of the maximum ‘x’ value and minimum ‘x’ value in the set, and establishing a base. Data points can be normalized to any base once they have completed a linear normalization. The following equation may be used:

$${x}^{′} = \frac{x - min ( x )}{max ( x ) - min ( x )} \qquad Equation ( 2 )$$

In this example, if a base of 100 is desired and there is an “x” value of 20, the max number is 55 and the min number is 5. To normalize this number, the base of 50 is calculated as 55−5. Now the numerator needs to be modified with the same approach, i.e., x−min(x). In this case, it becomes 15 (or 20−5). In short, the standardized x, or x′, is 15/50=0.3.

Now, to normalize to 100, it may be necessary to multiply or divide the fraction by the number needed to get the denominator to 100. In this example, let's multiply by 2. For instance, 50 is multiplied by 2 to get 100 and 15 is multiplied by 2 to get 30. The standardization is 30/100 or 0.3. This is done to all numbers in the data set to get a 100 base standardization.

Another type of normalization (not shown in figures) is clipping. Although clipping may not be a normalization technique, it may be considered a tool analysts use before or after using normalization techniques. In short, clipping may include establishing maximum and minimum values for the dataset and requalifying outliers to this new max or min value. If there is a dataset of numbers [14, 12, 19, 11, 15, 17, 18, 95], the number 95 is a large outlier compared to the others. It can be clipped out of the data by reassigning a new high. Since the range without 95 is 11−19, you could reassign the max value at 19. It's important to note that clipping does not remove points from a data set, but merely reassigns data in a dataset. A quick check to ensure it is performed correctly is to make sure the data population N is the same before and after clipping, but that no outliers exist.

In the example of standard deviation normalization 836, assume that there are five rows with the IDs A, B, C, D, and E, each row containing ‘n’ different variables (columns). In this example, row E can be used. The remaining rows are normalized in the same way. The normalized value of eᵢ for row E in the i^{th} column is calculated as:

$$Normalized ( {e}_{i} ) = \frac{{e}_{i}}{std ( E )} \qquad Equation ( 3 )$$

$$where$$

$$s td ( E ) = \sqrt{\frac{1}{( n - 1 )}} {\sum }_{i = 1}^{n} {( {e}_{i} - \overline{E} )}^{2} \qquad Equation ( 4 )$$

$$and$$

$$\overline{E} = \frac{1}{n} {\sum }_{i = 1}^{n} {e}_{i} . \qquad Equation ( 5 )$$

If all values for row E are identical, the standard deviation of E (std(E)) is equal to zero and all values for row E are set to zero.

The result of one or more of the normalization examples is an output of database 838. The database is the source of information for data collected from all external sources. Output to external systems may require automatic reformatting of data to fit within form fields on external systems. In some cases, the data may be clipped or deviate from the standardized data format in such a way that restricting the normalization standards to that level would sacrifice data integrity across all platforms. In this case, output data that is manipulated is saved in a standardized format.

In operation, the data received 810 may be inputted manually 812 for staging 816, parsing 818 and validation 822 prior to the one or more normalization processes. Data may be presented to a user interface via an API 814, which is managed by a synchronization engine 852. The output of the database 838 may include data that is prepared 840 for insertion in one or more output interfaces used by a consumer software application. The data may be prepared for a form field validation and normalization process 842 and may be converted 844 based on the available formats stored in the database 838. The data may be presented 846 in a visual format and queried by any one or more of the known data management applications (e.g., ORACLE, NETSUITE, QUICKBOOKS, SALESFORCE, etc.). The result of a query 848 initiated to identify a specific data realization may be visualized 850 in an application interface.

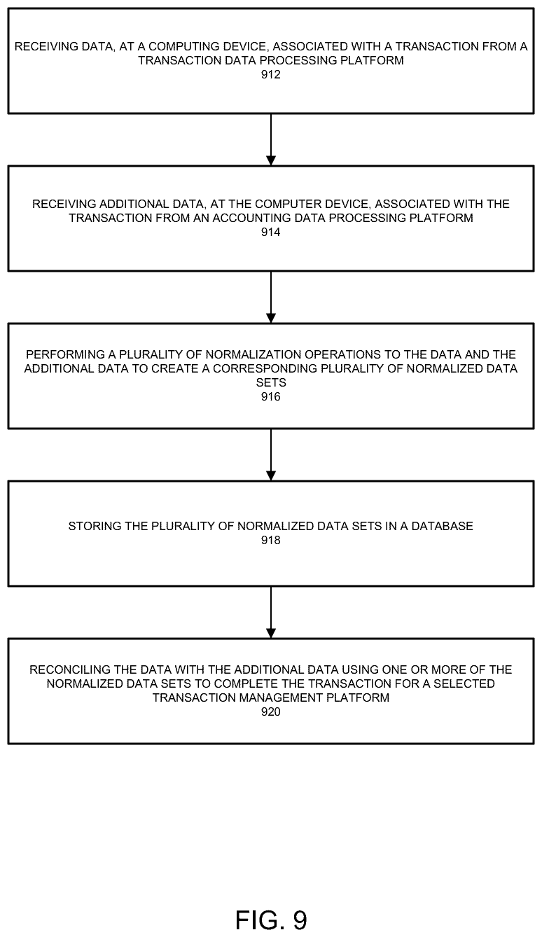

FIG. 9 is a flow diagram of an example method of normalizing data for synchronization across platforms, according to an embodiment of the present invention. In some embodiments, the method may include a step 912 where the computer system 100 receives data associated with a transaction from a financial platform. The method may include a step 914 where the computer system 100 receives additional data from a second financial platform. The method may include a step 916 where the computer system 100 performs normalization functions on the data and the additional data to generate normalized data. The method may include a step 918 where the computer system 100 stores the normalized data. The method may include a step 920 where the computer system 100 reconciles the data. This method is discussed in greater detail as illustrated by the method 1700 below.

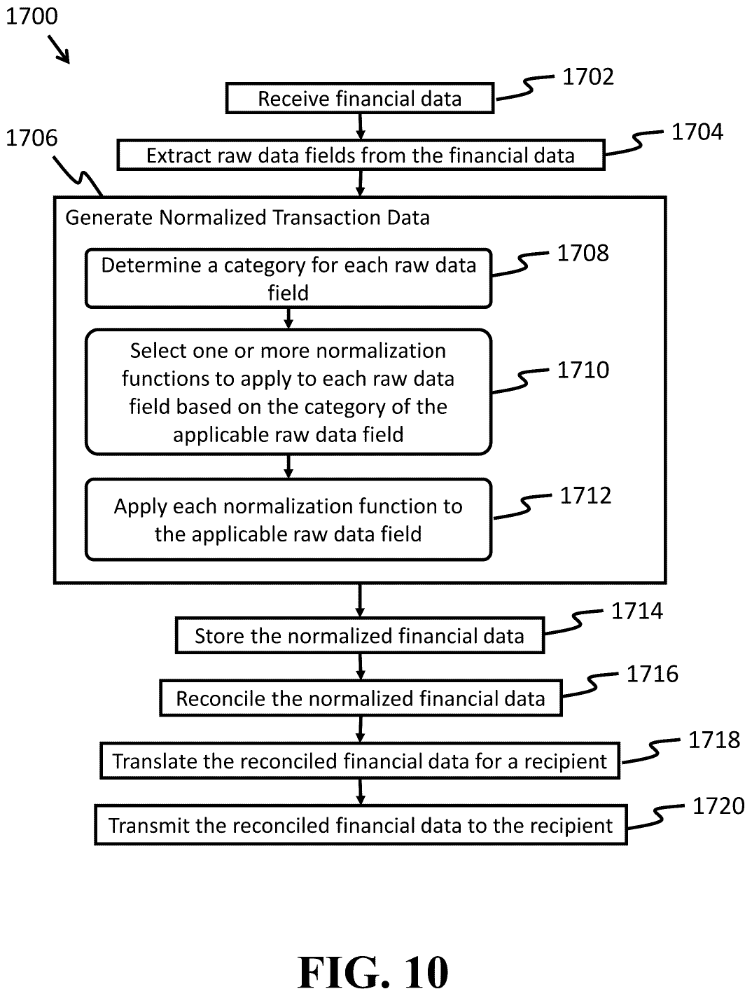

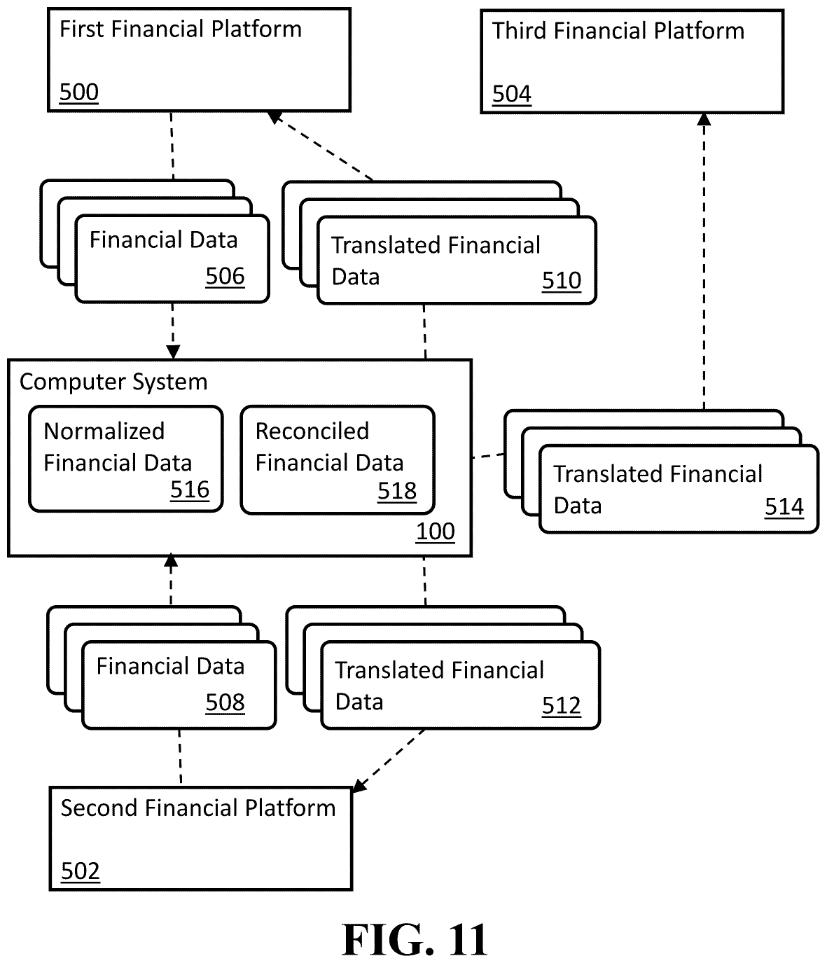

Referring now to FIGS. 10-12, an example method for normalizing data for synchronization across platforms is shown, according to further embodiments of the present invention. Referring particularly to FIG. 10, a method 1700 is shown. The method 1700 may begin with a step 1702, the computer system 100 may receive financial data. For instance, and with reference to FIG. 11, the computer system 100 may receive a number of sets of financial data, such as the data received 810 via staging 816 depicted with reference to FIG. 8.

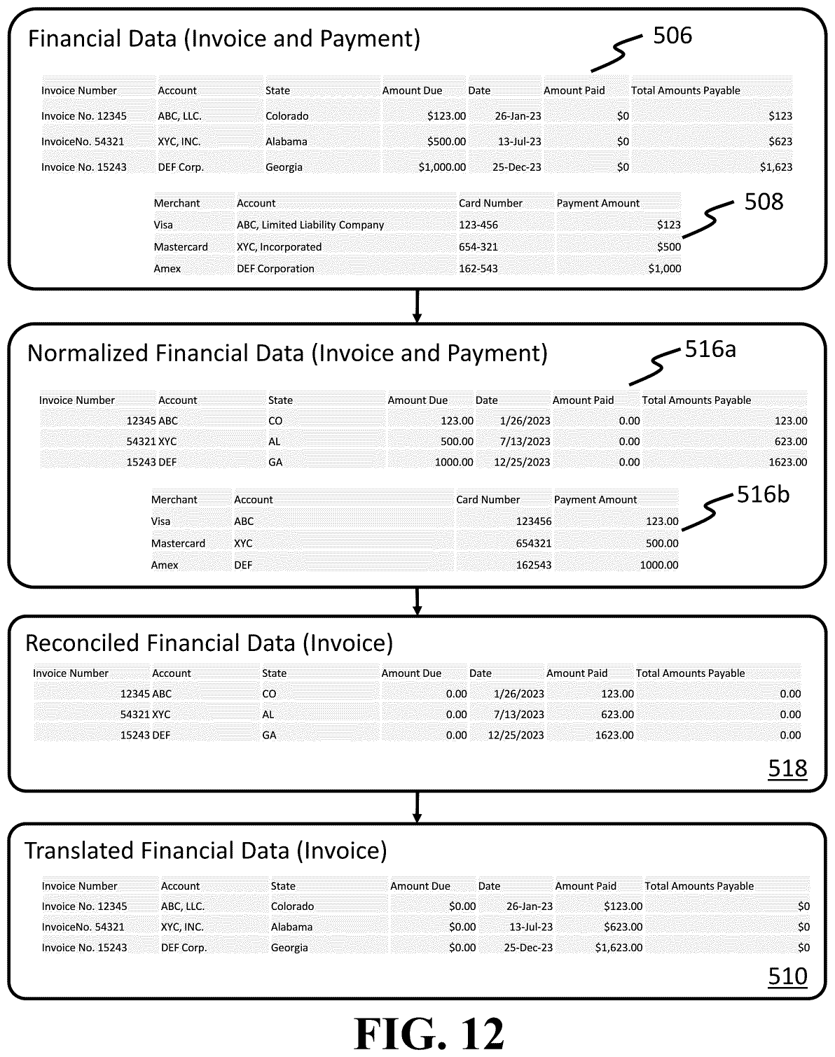

The number of sets of financial data (e.g., the data received 810) may include a first set of financial data 506 received from a first financial platform 500, and a second set of financial data 508 received from a second financial platform 502. For each of the first and second sets of financial data 506, 508, the financial data may include a number of raw data fields associated with a number of categories of financial data. As an example, and with reference to FIG. 12, the first set of financial data 506 may be invoice or accounting data provided by a data management application (e.g., e.g., ORACLE, NETSUITE, QUICKBOOKS, SALESFORCE, etc.), the payment gateway 110, or the cashless payment entity 120, and therefore include categories of financial data such as an invoice number, an account, a state, an amount due, a date, an amount paid, and a running total amounts payable category. Similarly, the second set of financial data 508 may be payment data (submitted by the aforementioned sources or other applicable entities), and therefore include categories of financial data such as a merchant, an account, a card number, and a payment amount for processing. In this sense, the first set of financial data 506 may include a “raw data field” of the “invoice number” category. Such a data field may be referred to as “raw” in light of the subsequent steps of normalization, reconciliation, and translation discussed herein.

Accordingly, the computer system 100 may be configured for extracting, from a number of sets of financial data (e.g., the first and second sets of financial data 506, 508), a number of raw data fields associated with a number of categories of financial data, where the number of sets of financial data includes at least a first set of financial data received from a first financial platform (e.g., the first financial platform 500) and a second set of financial data received from a second financial platform (e.g., the second financial platform 502).

Returning again to FIG. 10, the method 1700 may proceed with a step 1704, where the computer system 100 extracts, from the number of sets of financial data, the raw data fields. Such a process may be performed by the parser 818 depicted with reference to FIG. 8.

The method 1700 may proceed with a step 1706, where the computer system 100 generates normalized transaction data. Such a process may be performed by the validator 822 depicted with reference to FIG. 8. For instance, with respect to each “raw data field,” the computer system 100 may determine a category of the raw data field in a step 1708. Referring again to the “invoice number” raw data field of the first set of financial data 506 depicted in FIG. 12, the computer system 100 may reference the title “invoice number,” as well as the values thereunder (“Invoice No. 123456,” “Invoice No. 54321,” etc.) and determine within a confidence threshold, that the raw data field is of the category “invoice number.” In turn, with respect to each raw data field, the computer system 100 (e.g., the validator 822) may select one or more normalization functions to apply to each raw data field based on the category. For example, each of the normalization functions 824, 826, 828, 832, 834, and 836 may be pre-determined and stored in the database 838, and may be selected based on the determination made in step 1710.

The method 1700 may then proceed with a step 1712, where the computer system 100 applies each of the normalization functions selected in step 1710 to the raw data field. For example, referring again to the “invoice number” raw data field of the first set of financial data 506 depicted in FIG. 12, the normalization functions may be applied such that the “invoice number” data field may be normalized to remove the leading “invoice no.” text, leaving the trailing numeric values in the data field as shown in the corresponding normalized set of financial data 516. This normalized data field may thus be standardized with respect to any other record containing invoice numbers in the database 838. As discussed below, each such normalization function applied to each “raw” data field may be recorded by the computer system 100 in the database 838, for the purposes of ultimately transmitting the data back to a requesting financial platform.

Of course, the steps 1708, 1710, and 1712 as discussed above may be repeated for each “raw” data field of each set of financial data (e.g., the first and second sets of financial data 506, 508). Thus, the same steps may be applied to each of the remaining data fields depicted in the first set of financial data 506 in FIG. 12, as well as each data field depicted in the second set of financial data 508 depicted in FIG. 12. Thus, normalized data may be generated for all financial data received by the computer system 100, thus generating normalized financial data 516 as depicted with reference to FIG. 11 (and, more specifically, the first set of normalized financial data 516a and the second set of normalized financial data 516b depicted with reference to FIG. 12).

Accordingly, the computer system 100 may be configured for generating normalized financial data (e.g., the normalized financial data 516), the normalized financial data including a number of sets of normalized data having a number of normalized data fields each corresponding to a raw data field of the number of raw data fields, where generating each normalized data field includes: (1) determining, for a raw data field, a category of the number of categories of financial data, (2) based on the category, selecting one or more normalization functions from a number of normalization functions stored in the database, and (3) applying each of the selected one or more normalization functions to the raw data field in order to generate a normalized data field.

Referring again to FIG. 10, the method 1700 may proceed with a step 1714, where the computer system 100 stores the normalized financial data 516 in the database 838. The method 1700 may then proceed with a step 1716 where the computer system 100 generates reconciled financial data 518, as discussed with reference to the method S400. Such a step may be completed by the synchronization engine 852 depicted with reference to FIG. 8 In particular, the computer system 100 may reconcile the first set of normalized financial data 516a with the second set of financial data 516b. The computer system 100 may conduct this step 1716 successfully due to the fact that such financial data has been normalized, and thus corresponds to one another in terms of the values of the data fields. For instance, as shown with reference to FIG. 12, the normalized financial data 516a, which may be invoice data, is shown to be reconciled with the normalized financial data 516b, which may be payment data, thereby producing reconciled financial data 518 with respect to the invoice data. The “amount due” and “amount paid” data fields of the normalized financial data 516a has been shown to have accounted for the “paymount amount” data field of the normalized financial data 516b, and thus the reconciled financial data 518 is shown to be updated accordingly, (“0.00” values in the “amount due” data field, and corresponding values in the “amount paid” data field replacing the previous “0.00” values).

It should be appreciated that such reconciliation may be conducted for all financial data received or previously stored by the computer system 100, including the normalized financial data 516b, other related invoice data corresponding to other financial platforms, other related payment data corresponding to other financial platforms, related accounting data, related tax data, and so on. Such reconciliation may only be conducted accurately due to the fact that all such data has been normalized as discussed herein.

Accordingly, the computer system 100 may be configured to generate reconciled financial data (e.g., reconciled financial data 518) by reconciling the number of sets of normalized financial data (e.g., the normalized financial data 516), the reconciled financial data having a number of reconciled data fields each corresponding to a normalized data field of the number of normalized data fields.

Of course, such data has been reconciled within the internal framework of the computer system 100, and is not formatted in a manner that is useful for the associated platforms in communication with the computer system 100. In this sense, the computer system 100 may not be able to simply transmit the reconciled data 518 to the first financial platform 500 (in response to the query 848 depicted with reference to FIG. 8, for example), such that the reconciled data 518 is interpretable by the first financial platform 500. Rather, the computer system 100 may be required to translate the reconciled financial data 518 to the formatting used by the first financial platform 500. In response to a request from the first financial platform 500 for updated invoice data, for example, the computer system 100 may then select the reconciled financial data 518 for translation and, ultimately, transmission to the first financial platform 500. Of course, it should be appreciated that such a request may come from any financial platform associated with the computer system 100, and may be a request for any particular data fields, as opposed to all data fields corresponding to the first set of financial data 506 initially provided by the first financial platform 500.

Thus, the method 1700 may proceed with a step 1718 where the computer system 100 generates one or more translated data fields. For instance, if the first financial platform 500 requests updated data corresponding to the first set of financial data 506 initially transmitted to the computer system 100, the computer system 100 may reference the corresponding reconciled data fields, and apply one or more translation functions to each of the data fields making up the reconciled data. For each of the reconciled data fields (“invoice number,” “account,” “state,” and so on in the reconciled financial data 518 of FIG. 12), a series of translation functions may be applied to the values of the data field. For instance, as mentioned above, when normalizing a “raw” data field, the computer system 100 may store references to the normalization functions applied to the raw data field in order to normalize the data field. In this sense, the computer system 100 may apply a series of inverse (or otherwise appropriate) translation functions that “unwind” the adjustments generated by each normalization function. Moreover, for each financial platform, the computer system 100 may store the preferred formatting and contents associated with the requested data. In this sense, additional or alternative translation functions may be applied, and additional data may be transmitted to the requesting financial platform to optimally respond to the request for updated financial data. As an example, FIG. 12 depicts translated financial data 510 based on the reconciled financial data 518. The “amount due” data field, while retaining the reconciled “O” values, may be returned from the normalized format of “0.00 to the initially received formatting of “$0.00.” Such steps may be similarly conduced for each of the requested data fields.

Accordingly, the computer system 100 may be configured to select one or more reconciled data fields of the number reconciled data fields (e.g., the reconciled financial data 518) to be transmitted to the first financial platform (e.g., the first financial platform 500); and in response, may be configured to generate one or more translated data fields (e.g., the translated financial data 510) by applying one or more translation functions to the one or more reconciled data fields, wherein the one or more translation functions are based at least in part on the one or more normalization functions applied to each raw data field corresponding to each of the normalized data fields corresponding to the one or more reconciled data fields.

Finally, the method 1700 may conclude with a step 1720 where the computer system 100 transmits the reconciled financial data to the recipient, in this case the first financial platform 500, as further depicted with reference to FIG. 11. As further shown with reference to FIG. 11, additional financial platforms may request financial data. For instance, a third financial platform 504 may request data. In this sense, while the first financial platform 500 may be an accounting platform maintaining invoice data, and the second financial platform 502 may be a payment gateway providing or requesting payment data, a third financial platform 504 may be a cashless payment entity, to which payment data should be sent. As suggested above, the computer system 100 may include formatting functions that control the format of data provided to the third financial platform 504, the data fields that should be provided to the third financial platform 504 in order to fill a request, and so on. The computer system 100 may prepare translated data 514 based on this information, without having received raw financial data (and thus without a stored series of normalization functions to “unwind.” In any case, when transmitting financial data to such a cashless payment entity, the ability of the computer system 100 to provide accurate data that is includes the optimized data fields in the optimized formatting, may improve such transactions. For instance, a cashless payment entity such as a credit merchant may apply a risk evaluation to any transaction, which controls a transaction fee applied by the merchant. By providing optimized information as discussed herein, the risk evaluation may be reduced, thus reducing the transaction fees associated with the transaction.

Of course, the method 1700 discussed above (along with the other methods discussed herein) may be repeated for a number of different sets of financial data, and therefore allow for similar interactions with a number of additional or alternative financial platforms.

In some embodiments, the present disclosure improves the functionality of a computing device. For example, in one embodiment, the systems and methods described herein may facilitate the enhanced omnidirectional syncing of financial data. The systems and methods may improve the way a computing device, such as the computer system 100, stores, reconciles, and distributes financial data. For example, by normalizing the received financial data (e.g., the financial data 506 and the financial data 508 depicted with reference to FIG. 11) received from various disconnected sources (e.g., the first financial platform 500 and the second financial platform 502 depicted with reference to FIG. 11), and reconciling such financial data, the computer system 100 may be enabled to enhance the speed and accuracy of the reported financial data provided to such platforms. Moreover, such data may be received in a format that the financial platforms are configured to use and interpret, due to the identification, storage, and use of the corresponding translation functions. By storing such translation functions, the aforementioned enhancements may be provided without creating a cost of requiring advanced and cumbersome interpretations to be configured on each individual platform receiving the reconciled financial data. Such translation functions may be used repeatedly (due to repeated formats of “raw” data being provided by such platforms), thereby propagating the computational benefits of such stored translation functions.

As discussed herein, the present disclosure includes components that are not well-understood, routine, or conventional. For example, the determination of particular and bespoke combinations of normalization functions, which are converted to corresponding combinations of translation functions, is not conventional. This unconventional activity may result in more accurate financial data reported by the computer system 100, provided at greater speeds, with reduced computational effort.

It will be readily understood that the components of various embodiments of the present invention, as generally described and illustrated in the figures herein, can be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification can be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics can be combined in any suitable manner in one or more embodiments.

It should be noted that reference throughout this specification to features, advantages, or similar language does not imply that all of the features and advantages that can be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification can, but do not necessarily, refer to the same embodiment.

Furthermore, the described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention.

One having ordinary skill in the art will readily understand that the invention as discussed above can be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

Thus, although there have been described particular embodiments of the present invention of a new and useful SYSTEM AND METHOD FOR OMNIDIRECTIONAL SYNCING OF PAYMENT DATA, it is not intended that such references to particular embodiments be construed as limitations upon the scope of this invention.

What is claimed is:

1. A data processing system for reconciling financial data, the system comprising a computing device including a processor, a database, and a memory, the memory storing instructions operative by the processor to:
extract, from a plurality of sets of financial data, a plurality of raw data fields associated with a plurality of categories of financial data, wherein the plurality of sets of financial data includes at least a first set of financial data received from a first financial platform and a second set of financial data received from a second financial platform;
generate normalized financial data, the normalized financial data including a plurality of sets of normalized data having a plurality of normalized data fields each corresponding to a raw data field of the plurality of raw data fields, wherein generating each normalized data field includes:
determining, for a raw data field, a category of the plurality of categories of financial data,
based on the category, selecting one or more normalization functions from a plurality of normalization functions stored in the database, and
applying each of the one or more normalization functions to the raw data field in order to generate a normalized data field of the plurality of normalized data fields;
generate reconciled financial data by reconciling the plurality of sets of normalized financial data, the reconciled financial data having a plurality of reconciled data fields each corresponding to a normalized data field of the plurality of normalized data fields;
select one or more reconciled data fields of the plurality of reconciled data fields to be transmitted to the first financial platform;
generate one or more translated data fields by applying one or more translation functions to the one or more reconciled data fields, wherein the one or more translation functions are based at least in part on the one or more normalization functions applied to each raw data field corresponding to each of the normalized data fields corresponding to the one or more reconciled data fields; and
transmit the one or more translated data fields to the first financial platform.

2. The data processing system of claim 1, wherein the plurality of normalization functions includes:
a decimal place normalization function;
a data type normalization function;
a formatting normalization function;
a z-score normalization function;
a linear normalization function;
a clipping normalization function; and
a standard deviation normalization function.

3. The data processing system of claim 2, wherein the first financial platform is an accounting platform,
wherein the first set of financial data is invoice data received from the accounting platform,
wherein the second financial platform is a payment processing platform, and
wherein the second set of financial data is payment data.

4. The data processing system of claim 3, wherein the memory further stores instructions operative by the processor to:
select a second one or more reconciled data fields of the plurality of reconciled data fields to be transmitted to the second financial platform;
generate a second one or more translated data fields by applying one or more form field functions to the second one or more reconciled data fields, wherein the one or more form field functions are associated with input requirements of the external platform and stored in the database; and
transmit the second one or more translated data fields to the second financial platform.

5. The data processing system of claim 4, wherein a third set of financial data of the plurality of sets of financial data is the second one or more translated data fields.

6. The data processing system of claim 5, wherein a third set of financial data of the plurality of sets of financial data is received from an enterprise resource planning platform.

7. The data processing system of claim 6, wherein a fourth set of financial data of the plurality of sets of financial data is received from a customer relations management platform.

8. A data method for reconciling financial data, the method comprising:
extracting, from a plurality of sets of financial data, a plurality of raw data fields associated with a plurality of categories of financial data, wherein the plurality of sets of financial data includes at least a first set of financial data received from a first financial platform and a second set of financial data received from a second financial platform;
generating normalized financial data, the normalized financial data including a plurality of sets of normalized data having a plurality of normalized data fields each corresponding to a raw data field of the plurality of raw data fields, wherein generating each normalized data field includes:
determining, for a raw data field, a category of the plurality of categories of financial data,
based on the category, selecting one or more normalization functions from a plurality of normalization functions stored in the database,
applying each of the selected one or more normalization functions to the raw data field in order to generate a normalized data field, and
generating reconciled financial data by reconciling the plurality of sets of normalized financial data, the reconciled financial data having a plurality of reconciled data fields each corresponding to a normalized data field of the plurality of normalized data fields;
selecting one or more reconciled data fields of the plurality of reconciled data fields to be transmitted to a first financial platform of the plurality of financial platforms;
generating one or more translated data fields by applying one or more translation functions to the one or more reconciled data fields, wherein the one or more translation functions are based at least in part on the one or more normalization functions applied to each raw data field corresponding to each of the normalized data fields corresponding to the one or more reconciled data fields; and
transmitting the one or more translated data fields to the first financial platform.

9. The method of claim 8, wherein the plurality of normalization functions includes:
a decimal place normalization function;
a data type normalization function;
a formatting normalization function;
a z-score normalization function;
a linear normalization function;
a clipping normalization function; and
a standard deviation normalization function.

10. The method of claim 9, wherein the first financial platform is an accounting platform,
wherein the first set of financial data is invoice data received from the accounting platform,
wherein the second financial platform is a payment processing platform, and
wherein the second set of financial data of the plurality of sets of financial data is payment data.

11. The method of claim 10, further comprising:
selecting a second one or more reconciled data fields of the plurality of reconciled data fields to be transmitted to the second financial platform;
generating a second one or more translated data fields by applying one or more form field functions to the second one or more reconciled data fields, wherein the one or more form field functions are associated with input requirements of the external platform and stored in the database; and
transmitting the second one or more translated data fields to the second financial platform.

12. The method of claim 11, wherein a third set of financial data of the plurality of sets of financial data is the second one or more translated data fields.

13. The method of claim 12, wherein a third set of financial data of the plurality of sets of financial data is received from an enterprise resource planning platform.

14. The method of claim 13, wherein a fourth set of financial data of the plurality of sets of financial data is received from a customer relations management platform.

15. A non-transitory computer readable medium carrying computer executable instructions which, when executed by a processor, cause the processor to perform operations comprising:
extracting, from a plurality of sets of financial data, a plurality of raw data fields associated with a plurality of categories of financial data, wherein the plurality of sets of financial data includes at least a first set of financial data received from a first financial platform and a second set of financial data received from a second financial platform;
generating normalized financial data, the normalized financial data including a plurality of sets of normalized data having a plurality of normalized data fields each corresponding to a raw data field of the plurality of raw data fields, wherein generating each normalized data field includes:
determining, for a raw data field, a category of the plurality of categories of financial data,
based on the category, selecting one or more normalization functions from a plurality of normalization functions stored in the database,
applying each of the selected one or more normalization functions to the raw data field in order to generate a normalized data field, and
generating reconciled financial data by reconciling the plurality of sets of normalized financial data, the reconciled financial data having a plurality of reconciled data fields each corresponding to a normalized data field of the plurality of normalized data fields;
selecting one or more reconciled data fields of the plurality of reconciled data fields to be transmitted to a first financial platform of the plurality of financial platforms;
generating one or more translated data fields by applying one or more translation functions to the one or more reconciled data fields, wherein the one or more translation functions are based at least in part on the one or more normalization functions applied to each raw data field corresponding to each of the normalized data fields corresponding to the one or more reconciled data fields; and
transmitting the one or more translated data fields to the first financial platform.

16. The non-transitory computer readable medium of claim 15, wherein the plurality of normalization functions includes:
a decimal place normalization function;
a data type normalization function;
a formatting normalization function;
a z-score normalization function;
a linear normalization function;
a clipping normalization function; and
a standard deviation normalization function.

17. The non-transitory computer readable medium of claim 16, wherein the first financial platform is an accounting platform,
wherein the first set of financial data is invoice data received from the accounting platform,
wherein the second financial platform is a payment processing platform, and
wherein the second set of financial data of the plurality of sets of financial data is payment data.

18. The non-transitory computer readable medium of claim 17, wherein the instructions further cause the processor to perform operations comprising:
selecting a second one or more reconciled data fields of the plurality of reconciled data fields to be transmitted to the second financial platform;
generating a second one or more translated data fields by applying one or more form field functions to the second one or more reconciled data fields, wherein the one or more form field functions are associated with input requirements of the external platform and stored in the database; and
transmitting the second one or more translated data fields to the second financial platform.

19. The non-transitory computer readable medium of claim 18, wherein a third set of financial data of the plurality of sets of financial data is the second one or more translated data fields.

20. The non-transitory computer readable medium of claim 17, wherein a third set of financial data of the plurality of sets of financial data is received from an enterprise resource planning platform, and
wherein a fourth set of financial data of the plurality of sets of financial data is received from a customer relations management platform.
